(19) United States
(12) Patent Application Publication
(10) Pub. No.: US 2004/0024084 A1
(43) Pub. Date: Feb. 5, 2004

(54) Hydroxyacid-free dispersants and inks

(76) Inventors: Bradley Leonard Beach, Lexington, KY (US); Terence Edward Franey, Lexington, KY (US); Elaine Yeap Money, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/212,498

(22) Filed: Aug. 5, 2002

(51) Int. Cl. C03C 17/00; C09D 5/00

(52) U.S. Cl. 523/160; 523/161

(57) ABSTRACT

The invention relates to dispersants and inks for ink jet applications. Specifically, this invention relates to hydroxyacid free dispersants and inks made from hydroxyacid free dispersants as well as methods for removing hydroxyacids from dispersants. The removal of hydroxyacids from dispersants prior to ink formulation eliminates print head filter clogs associated with flocculation and hydroxyacid containing deposits on the filter, thereby increasing the useful life of the print head and improving print quality.

### FIELD OF THE INVENTION

This invention belongs to the field of organic chemistry. In particular, it relates to dispersants useful in ink jet ink compositions.

### BACKGROUND

Ink jet printing offers low cost and high quality printing options. Ink jet printing is accomplished by ejecting ink from a nozzle toward paper or another print medium. The ink is ejected from the nozzle in a number of ways. In electrostatic printing, the ink is driven from the nozzle with an electosteric field. Piezo-electric printing is accomplished by causing distortions of the piezo-electric element to pump the ink through the nozzle. In another ink jet printing procedure, known as thermal or bubble jet printing, the ink is forced from the nozzle by the formation of an expanding vapor phase bubble in the nozzle.

Ink compositions for use in ink jet applications generally comprise water, a water soluble or water miscible organic solvent and a colorant. The colorant may be a soluble dye or an insoluble pigment. Inks comprising water soluble dyes often exhibit poor lightfastness, waterfastness, and tend to clog the print head nozzles as a result of solvent evaporation and changes in the dyes solubility. Dye based inks also tend to bleed and feather when deposited on plain papers. Additionally, many exhibit poor thermal stability, chemical instability, are prone to crystallization and are easily oxidized.

In pigmented ink compositions, a dispersant is required as most pigments are not water soluble. The dispersant stabilizes the pigment particles through an electrostatic stabilizing mechanism in which a hydrophobic group in the dispersant acts as an anchor absorbed on the pigment particle surface through acid-base relation, electron donor/acceptor relation, Van der Waals forces or physical absorption. In this system, a hydrophilic group in the dispersant is extended into the aqueous medium to keep the dispersant soluble and set up an electrostatic layer to prevent aggregation of the particles. This results in a competition in the dispersing process between the pigment particle and the polymer, the polymer and the solvent, and the pigment particle and the solvent.

Ink jet printers make use of very small nozzles, often less than 800 micrometers in diameter. This is necessary to provide the high resolution and print detail which consumers demand. Unfortunately, pigment particles tend to agglomerate which can restrict or clog the nozzle. This is known as “plugging”. Additionally, in the case of thermal ink jet printing, there is a tendency for materials to settle onto the heating elements of the printer heads. This causes a decreased thermal efficiency which results in formation of smaller ink droplets and lower image quality. This effect is commonly known as “kogation”. To overcome these problems some water based pigmented ink compositions have employed dispersants.

In order to form a stable polymeric dispersion, several factors must be considered. First, the polymer must be firmly adsorbed on the pigment surface to withstand shear force and the competition of other chemical species. This requires a careful match of the polarity of the pigment surface to the hydrophobic group in the dispersant. Second, the physical dimensions of the hydrophobic group in the dispersant must be adequate to fully cover the pigment surface, otherwise, the adsorbed polymer will act as a flocculent. Third, an electrostatic layer of requisite thickness around the particle is needed to repulse aggregation of particles within the aqueous medium.

It is common to add binders, solvents, surfactants, humectants, defoamers, biocides and other additives to pigmented ink compositions to optimize print quality, dry time and maintenance characteristics. These additives may compete with the anchor group in the dispersant to absorb on the pigment particle surface, and may also lower the solubility of the polymer in the media especially at higher temperatures, thereby destabilizing the dispersion system. Destabilized dispersions can result in flocculation of the pigment in the nozzle of the ink jet printer which can adversely affect the printing process. Accordingly, there remains a need in the art for new and better dispersants which eliminate flocculation problems.

The present invention eliminates print head filter clogs caused by residual hydroxyacids, in the dispersants. Another feature of the present invention comprises the elimination of clogging of the filter within the print head. The present invention also eliminates flocculation on the print head. These advantages result in fewer failed nozzles and a longer useful print head life. The resulting ink formulations display better print quality and less maintenance of the print head.

### SUMMARY

The present invention relates to a dispersant composition comprising a dispersant wherein hydroxyacids present in said dispersant have been removed. The hydroxyacids present in the dispersants of the present invention may be removed through an ultrafiltration process.

The present invention also comprises pigment dispersions comprising a dispersant wherein hydroxyacids present in the dispersant have been removed and a pigment has been dispersed in the dispersant.

The present invention also relates to ink compositions comprising a dispersant composition comprising a dispersant wherein hydroxyacids present in said dispersant have been removed.

The present invention also relates to a method of preparing a dispersant composition comprising the steps of removing hydroxyacids present in a dispersant from the dispersant.

Additionally, a method of preparing an ink composition is provided comprising the steps of removing hydroxyacids present in a dispersant from said dispersant to form a hydroxyacid free dispersant composition and combining the hydroxyacid free dispersant composition with a colorant and a vehicle.

Further provided is a method of preparing a dispersant composition wherein an ultrafiltration process is applied to a dispersant comprising one or more hydroxyacids thereby separating the dispersant into a first stream comprising a hydroxyacid free dispersant composition and a second stream comprising one or more hydroxyacids.

### BRIEF DESCRIPTION OF THE DRAWINGS

FIG. 1 is a side view of an ink testing apparatus.

FIG. 2 is a graph showing filtrate mass vs. time.

FIG. 3 is a graph showing filterability vs. aging time.

FIG. 4 is a schematic of a ultrafiltration system.

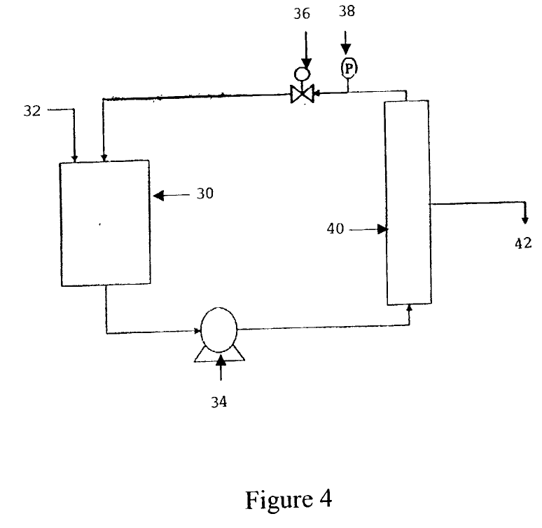

### DETAILED DESCRIPTION

The present invention arises from the following research and discoveries of the inventors. First, it was determined that inkjet ink containing a latex binder and a dispersed pigment, such as carbon black, forms a flocculated material that manifests itself as a clog on the downside portion of the filter in the print head assembly. Second, it was determined that these clogs contain flocculated binder, pigment and dispersant. Upon analysis by pyrolysis/gas chromatography/mass spectrometry (gc/ms), it was also found that they contain an unexpected pyrolysis product, crotonic acid.

The present inventors then determined that crotonic acid was being produced from the pyrolysis of a non-volatile flocculation of a hydroxyacid, in this case 3-hydroxybutyric acid (3-HBA). Upon further investigation it was discovered that other hydroxyacids cause similar filter clogs. The source of the hydroxyacid was determined to be the terpolymer dispersant used in the manufacturing of the dispersant. A common component of most dispersants is methacrylic acid (MAA). MAA is produced through the dehydration of 2-hydroxy2-methylpropanoic acid. 3-HBA exists as an impurity in 2-hydroxy2-methylpropanoic acid. Thus, the majority of commercially available dispersants unintentionally contain hydroxyacids as an impurity. The present inventors determined, however, that if the hydroxyacids were removed from the dispersant, inks made from these “clean” dispersants did not display any crotonic acid containing clogs on the filters. Thus, the present invention comprises, inter alia, a method for eliminating a major source of flocculation in ink compositions by the removal of all hydroxyacids from the dispersant.

It should be noted that the removal of “all” hydroxyacids refers to removal of hydroxyacids to an imperceptible level in current gas or liquid chromatograph or mass spectrometry analysis. Similarly a “hydroxyacid free” dispersant will contain no perceptible hydroxyacids through the aforementioned testing means. While removal of 100% of the hydroxyacids may be possible, removal to an immeasurable level is all that is required for the practice of the present invention.

For the purposes of this invention it should be noted that the term “hydroxyacid(s)” refers to all organic compounds containing both the hydroxyl (OH) and carboxyl (COOH) radicals.

The present invention comprises a dispersant from which all hydroxyacids have been removed.

In a further embodiment, the present invention comprises a process for removing hydroxyacids from dispersants.

A method of the present invention for removing hydroxyacids from the dispersant comprises ultrafiltration. Ultrafiltration separates a solute (hydroxyacids) from a solution (dispersant) based on differences in the molecular size and shape. Under an applied pressure difference across an ultrafiltration membrane, solvent and small solute particles pass through the porous membrane and are discharged in a filtrate stream while larger species are retained by the membrane and recovered as concentrated retanate. In the present invention, hydroxyacids and water pass through the membrane while the larger dispersant particles remain in the retanate. Advantages of separation by ultrafiltration are the simplicity of the operation; a lack of moving parts other than pumps, and low energy cost relative to other separation means which require a phase change such as distillation and freezing.

Selection of membranes for use in the ultrafiltration process depends on the following performance requirements: (1) the membranes affinity for solvent over solute, which controls the number of stages necessary to deplete the dispersant of hydroxyacids to the desired final concentration; (2) permeation rate of solvent relative to the pressure gradient, which determines the size of each stage and the size of the overall process relative to the desired throughput; and (3) membrane durability, which determines the usable life of the membrane relating to down time and maintenance cost.

It should be noted that ultrafiltration and reverse osmosis are closely related processes. It is generally accepted that ultrafiltration is used when solutes have dimensions 10 times or more those of the solvent and are generally below 0.5 micrometers in size. The terms “ultrafiltration” and “reverse osmosis” both describe pressure driven membrane separation processes and the words may be used interchangeably to describe the processes and apparati of the present invention.

Any dispersants known in the art may be cleaned in the practice of the present invention. The source of the hydroxyacids present in the dispersant (in addition to the source described above) may be residual unreacted hydroxyacids remaining from the polymerization process, impurities which existed in the starting materials, or unknown. The source of the hydroxyacids, however, is unimportant to the practice of the present invention. Preferred dispersants for use in the present invention include meth/acrylic copolymer dispersants.

In another embodiment, the present invention comprises an ink composition suitable for use in ink jet applications comprising a colorant, a vehicle, the hydroxyacid free dispersant of the present invention and optionally other ink components and additives known in the art.

Colorants/Dispersants

Colorants useful in the present invention comprise pigments, self-dispersed pigment blends, polymeric pigment dispersions, pigment-dye blends, insoluble dyes, and combinations thereof. The pigment can be a polymeric pigment concentrate or self-dispersed pigment concentrate, or a combination of both.

As is known in the art, a pigment dispersion comprises a mixture of a pigment and a dispersing agent, typically a polymeric dispersant compound. A wide variety of organic and inorganic pigments, alone or in combination, may be selected for use in the aqueous inks of the present invention. The key selection criterion for the pigment is that they must be dispersible in the aqueous medium. The term “pigment,” as used herein, means an insoluble colorant. The selected pigment may be used in dry or wet form.

Suitable pigments include organic and inorganic pigments, and essentially any of the classes of pigments heretofore used in this art, of a particle size sufficient to permit free flow of the ink through the ink jet printing device, especially at the ejecting nozzles that usually have a diameter ranging from about 10 microns to about 50 microns. Thus, a suitable pigment particle size ranges from about 0.02 to about 15, preferably from about 0.02 to about 5, and more preferably from about 0.02 to about 1, micron(s). Pigments suitable for use in the present invention include azo pigments, such as azo lakes, insoluble azo pigments, condensed azo pigments and chelate azo pigments, polycyclic pigments, perylene pigments, anthraquinone pigments, quinacridone pigments, dioxazine pigments, thioindigo pigments, isoindolinone pigments, quinophthalone pigments, and dry lakes. Suitable organic pigments include nitro pigments, aniline black and daylight fluorescent pigments. Preferred pigments include carbon black, Pigment Red 122, Pigment Red 202, Pigment Yellow 74, Pigment Yellow 128, Pigment Yellow 138, Pigment Yellow 155, Pigment Blue 15:3 and Pigment Blue 15:4.

Appropriate dispersants for use in the present invention include those known in the art, such as the acrylic terpolymers taught in commonly-assigned U.S. Pat. No. 5,719,204, and other commonly known dispersants. Factors to be considered in selecting an appropriate dispersant include the following: First, the dispersant must firmly anchor to the pigment particle surface to withstand shear force and the competition of other chemical species. To ensure this anchoring, a careful match of the polarity of the pigment particle surface and the hydrophobic group in the dispersant is required. Second, the physical dimensions of the hydrophobic group in the dispersant must be adequate to fully cover the pigment surface, otherwise, the adsorbed polymer will act as a flocculent. Third, an electrostatic layer of a requisite thickness around the particle is needed to prevent aggregation of particles within the aqueous medium.

Once a dispersant has been selected, any hydroxyacids are removed according to the method of the present invention to create a dispersant composition which is hydroxyacid free. The pigment to dispersant (weight) ratio is preferably from about 3:1 to about 5:1, but may vary from about 1:1 to about 9:1.

Dyes that are commonly used in ink jet inks such as, for example, Acid, Direct, Food, and Reactive dyes, are all suitable for use as colorants in the present invention. Essentially any dye that permits the formation of colored visible images on a recording medium may be used, including anthraquinones, mono- and di-azo dyes, phthalocyanines, and formazan copper complexes. Dye-pigment blends are preferred as they provide better waterfastness and lightfastness.

The amount of colorant in the ink composition may be varied depending on a number of factors, including structure, but the colorant is commonly present in an amount of from about 0.5% to about 10%, preferably of from about 2% to about 6%, by weight of the ink composition (based on total weight of the ink). In a preferred embodiment of the present invention, the pigment utilized in the ink formulation comprises pigment in a concentration of from about 3% to about 4% by weight.

Vehicle

To aid in maintaining the colorant in solution and enhance ink performance, a co-solvent may be present in the ink composition. Inclusion of an aqueous carrier medium, which is generally present at from about 40% to about 99% of the composition, is preferred. The aqueous carrier medium comprises water (preferably deionized water) and, preferably, at least one water soluble organic solvent.

Selection of a suitable carrier mixture depends on the requirements of the specific application involved, such as desired surface tension and viscosity, the selected pigment, the desired drying time of the ink, and the type of paper onto which the ink will be printed. Representative examples of water soluble organic solvents that may be selected include: (1) alcohols, such as methyl alcohol, ethyl alcohol, n-propyl alcohol, isopropyl alcohol, n-butyl alcohol, sec-butyl alcohol, tbutyl alcohol, iso-butyl alcohol, furfuryl alcohol, and tetrahydrofurfuryl alcohol; (2) ketones or ketoalcohols, such as acetone, methyl ethyl ketone and diacetone alcohol; (3) ethers, such as tetrahydrofuran and dioxane; (4) esters, such as ethyl acetate, ethyl lactate, ethylene carbonate and propylene carbonate; (5) polyhydric alcohols, such as ethylene glycol, diethylene glycol, triethylene glycol, propylene glycol, tetraethylene glycol, polyethylene glycol, glycerol, 2-methyl-2,4-pentanediol, 1,2,6-hexanetriol and thiodiglycol; (6) lower alkyl mono- or di-ethers derived from alkylene glycols, such as ethylene glycol monomethyl (or monoethyl) ether, diethylene glycol monomethyl (or monoethyl) ether, propylene glycol monomethyl (or monoethyl) ether, triethylene glycol monomethyl (or monoethyl) ether and diethylene glycol dimethyl (or diethyl) ether; (7) nitrogen-containing cyclic compounds, such as pyrrolidone, N-methyl-2-pyrrolidone, and 1,3-dimethyl-2-imidazolidinone; and (8) sulfur-containing compounds, such as dimethyl sulfoxide and tetramethylene sulfone. Other useful organic solvents include lactones and lactams. Examples of suitable substituted or unsubstituted lactams include 2-pyrrolidone, 1-methyl 2-pyrrolidone, and N-(2-hydroxyethyl)-2-pyrrolidone. Co-solvents may also include 1°, 2°, and 3° amides, either alone or in a mixture with any of the above-mentioned co-solvents. Mixtures of these solvents may be used in the present invention.

Co-solvents are typically present in an amount of from about 5% to about 30% by weight, and more preferably from about 10% to about 30% by weight, including all ranges subsumed therein. As will be appreciated, the amounts of cosolvent will be dependent in part on the other components of the ink.

Preferred co-solvents for use in the present invention include a compatible mixture of a lactam, such as 2-pyrrolidone (from about 1% to about 15%, and preferably from about 3% to about 10% by weight) and polyethylene glycol (from about 1% to about 15% by weight).

Other Components

The ink composition of the present invention may also include other desirable components which have heretofore been included in jet printing ink compositions including binders, penetrants, surfactants, chelating agents, biocides, buffer, pH Adjustors, humectants, thickeners and viscosity modifiers.

Binder

A binder may also optionally be used in the ink composition of the present invention to bridge the pigment particles within the ink and aid in their adhesion to the print medium. The use of a binder allows for greater ink durability and increased image permanence. High T_{G} binders are generally preferred for long term jetting requirements, but low T_{G} binders are preferable for smear permanence. Also preferred are unimodal random (not block) polymer binders. Binder may be present in amounts from 0-100 parts to 100 parts of pigment, preferably 5-30 parts to 100 parts pigment.

Preferred binders for use in the present invention comprise a polymer or copolymer formed from monomer classes, including, but not limited to: acrylate esters, methacrylate esters, styrenes, substituted styrenes, vinyl acrylates, vinyl acetates, fluoromethacrylates, acrylamides, substituted acrylamides, methacrylamides, substituted methacrylamides, and combinations thereof. Among the esters of acrylic acid and methacrylic acid, preferred monomers include methyl acrylate, ethyl acrylate, propyl acrylate, butyl acrylate, lauryl acrylate, methyl methacrylate, ethyl methacrylate, propyl methacrylate, butyl methacrylate, lauryl methacrylate, and isobutylene methacrylate.

In one embodiment, the binder may comprise a copolymer of butyl acrylate and methyl methacrylate. In a further embodiment, the polymeric binder may comprise a copolymer ranging from about 20% to about 40% by weight of methyl methacrylate and about 60% to about 80% by weight of butyl acrylate. The polymeric binder may comprise a copolymer ranging from about 27% to about 33% by weight of methyl methacrylate and about 66% to 72% by weight of butyl acrylate. In another embodiment, the polymeric binder comprises 10% to 50% by weight methyl methacrylate, 50% to 85% by weight butyl acrylate, and 3% to 10% by weight methacrylic acid, based on the total weight of the polymeric binder; for example 14.5% by weight methyl methacrylate, 80.5% by weight butyl acrylate, and 5% by weight methacrylic acid. The foregoing merely represent example of suitable polymeric binder compositions.

The polymeric binder further comprises an acid component. The acid component may comprise acrylic acid, methacrylic acid, itaconic acid, vinyl sulfonic acid, maleic acids or combinations thereof, or may be derived from salts or anhydrides of such acids, such as methacrylic or maleic anhydride or sodium vinylsulfonate or acrylomidopropane sulfonate. In one embodiment the acid component is methacrylic acid. In another embodiment, the acid component is methacrylic acid in combination with another acid. The acid component of the polymeric binder ranges from about 1% to about 10% by weight of the total weight of the polymeric binder. In one embodiment, when the acid component is methacrylic acid, the acid component is about 1.1% to about 1.5% by weight of the total weight of the polymeric binder. In another embodiment, when the acid component is methacrylic acid, the acid component is about 1.3% by weight of the total weight of the polymeric binder.

It should be noted, however, that the examples of ink compositions discussed herein do not represent the only possible formulations encompassed by the present invention, and that the present invention includes ink compositions when the acid component of the polymeric binder ranges from about 1% to about 10% by weight of the total weight of the polymeric binder.

The most preferred binder in the present invention may comprise from about 0% to about 5% ACRYJET 3666® by weight in the ink composition. ACRYJET 3666®is a proprietary unimodal acrylic emulsion obtained from Rohm & Haas, which contains a random copolymer comprised of butylmethacrylate and methylmethacrylate monomers.

Penetrant

A penetrant may also optionally be used in the ink composition of the present invention to improve penetration by the ink drops into the surface of the printed substrate and to reduce or eliminate intercolor bleeding (i.e., lateral bleeding of color). Penetrants (which include surfactants) are preferred for use in the invention. Preferred penetrants for use in the present invention include 1,2 alkyl diols containing from about 4 to about 10 carbon atoms in the alkyl group such as those taught in commonly-assigned U.S. Pat. No. 5,364,461. Most preferred are 1,2-hexanediol and hexyl carbitol. In a preferred embodiment, the penetrant is present in the ink composition in an amount of from between about 0.1% to about 10% by weight, preferably 0.3% to about 3%.

Surfactant

Surfactants, such as for example, SILWET®, may be added to modify the surface tension of the inks of the present invention and to control the penetration of the ink into the paper. Such surfactants are included in the ink compositions, and are not a component of the dispersant. Suitable surfactants include nonionic, amphoteric and ionic surfactants, preferred surfactants include alkyl sulfate, nonyl phenyl polyethylene glycol, SILWET®(OSI Sealants, Inc.), TERGITOL®(Union Carbide) and SURFYNOL®(Air Products and Chemicals, Inc.).

Chelating Agent

Chelating agents, such as for example, ethylene diamine tetraacetate (EDTA), diethylene triamino pentasodium acetate and uramil disodium acetate, may be added to prevent any deleterious effects from metal or alkali metal ion contaminants or impurities. Typically, a chelating agent may be added to the composition in an amount of from about 0.1% to about 1.0% by weight. A preferred chelating agent is EDTA.

Biocide

Biocides, such as for example, 1,2-benz-isothiazolin-3-one, may be added to the ink to prevent or inhibit growth of microorganisms in the ink. A preferred biocide is Proxel® GXL, available from Avecia, Inc., Wilmington, Del. Generally, the addition of from about 0.1% to about 1.9% by weight of a biocide will be efficacious, preferably from about 0.1% to about 0.2%

Buffer

Buffering agents, such as borax, borates, phosphates, polyphosphates or citrates (for example, sodium borate, sodium tetraborate, sodium phosphate, sodium dihydrogen phosphate, disodium hydrogen phosphate, sodium tripolyphosphate, sodium pentapolyphosphate and sodium citrate) may also be added to adjust or maintain a desired pH for the ink. A preferred buffer is potassium hydroxide. As will be appreciated, the amount of buffer will depend on the other components in the ink. However, it has been found that the addition of small amounts of buffer to the ink, such as from about 0.01% to about 0.3% by weight, is useful (preferably from 0.1 to 1% by weight.)

Ph Adjustors

As pH adjustment agents, any materials can be used optionally so long as they do not have an adverse effect on the ink composition and can control the pH of the ink composition within the range of pH 5.0 to 11, preferably from 7.0 to 10.0. Specific examples of such pH adjustment agents are amines, such as diethanolamine and triethanolamine; hydroxides of alkali metals, such as lithium hydroxide, sodium hydroxide and potassium hydroxide; ammonium hydroxide; and carbonates of alkali metals, such as lithium carbonate, sodium carbonate, potassium carbonate, and acetic acid.

Humectant

The aqueous carrier medium, generally present at from about 70% to about 99.5% of the composition, may also optionally comprise water, preferably deionized water, and, preferably, at least one water soluble organic solvent acting as a humectant. Selection of a suitable carrier mixture depends on the requirements of the specific application involved, such as desired surface tension and viscosity, the desired drying time of the ink, and the type of paper onto which the ink will be printed.

Representative examples of humectants that may be selected include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) ketones or ketoalcohols, such as acetone, methyl ethyl ketone and diacetone alcohol; (3) ethers, such as tetrahydrofuran and dioxane; (4) esters, such as ethyl acetate, ethyl lactate, ethylene carbonate and propylene carbonate; (5) polyhydric alcohols, such as ethylene glycol, diethylene glycol, triethylene glycol, propylene glycol, tetraethylene glycol, polyethylene glycol, glycerol, 2-methyl-2,4-pentanediol, 1,2,6-hexanetriol and thiodiglycol; (6) lower alkyl mono- or di-ethers derived from alkylene glycols, such as ethylene glycol monomethyl (or monoethyl) ether, diethylene glycol monomethyl (or monoethyl) ether, propylene glycol monomethyl (or monoethyl) ether, triethylene glycol monomethyl (or monoethyl) ether and diethylene glycol dimethyl (or diethyl) ether; (7) nitrogen-containing cyclic compounds, such as pyrrolidone, N-methyl-2-pyrrolidone, and 1,3-dimethyl-2-imidazolidinone; and (8) sulfur-containing compounds, such as dimethyl sulfoxide and tetramethylene sulfone. Other useful organic solvents include lactones and lactams. Mixtures of these solvents may be used in the present invention.

Of the above mentioned humectants, preferred humectants are diethylene glycol, polyethylene glycol (200 to 600), ethylene glycol, triethylene glycol, tetraethylene glycol, glycerin and N-methyl-2-pyrrolidone, by which the solubility of the employed dye in the solvent of the ink composition can be increased and the evaporation of water from the ink composition can be appropriately controlled, so that the initial properties of the ink composition can be maintained even for an extended period of continuous use or storage, or during the periods when the apparatus is not in use, whereby reliable ink droplet stability and ink droplet ejection response of the ink composition, particularly after a prolonged period of non-use of the apparatus, are obtained. The amount of humectant is determined by the desired properties of the ink and may range from about 1% to about 30% by weight of the ink composition.

Thickeners/Viscosity Modifiers

Ink compositions of the present invention may also optionally comprise thickeners of natural or synthetic origin for the purpose of adjusting the viscosity. Examples of thickeners that may be mentioned are commercially available alginarte thickeners, starch ethers or locust bean flour ethers, especially sodium alginate on its own or in admixture with modified cellulose, e.g. methylcellulose, ethycellulose, carboxymethycellulose, hydroxyethylcellulose, methylhydroxycellulose, hydroxypropyl cellulose or hydroxypropyl methylcellulose, especially with preferably from 20 to 25% by weight carboxymethylcellulose. Synthetic thickeners that may be mentioned are, for example, those based on poly(meth)acrylic acids or poly(meth)acrylamides. Thickeners may be present in an amount from 0.1 to 2% by weight, especially from 0.01 to 1% by weight and preferably from 0.01 to 0.5% by weight, based on the total weight of the ink.

Other additives, for example, ultraviolet absorbers, antioxidants, light stabilizers may be added as necessary in specific embodiments of an aqueous ink composition for ink jet printing according to the present invention.

Preparation Of Inks

The process of preparing pigment based dispersions and inks generally involves two steps: (a) a dispersing or milling step which breaks up the pigment into its primary particles and mixes the particles with a dispersant, and (b) a dilution step in which the dispersed pigment is diluted with an aqueous carrier and other additives into a final ink composition. The hydroxyacid free dispersions of the present invention can be prepared in a customary manner by milling the pigment with a hydroxyacid free dispersant through conventional milling processes to create a hydroxyacid free pigment dispersion. Then, the hydroxyacid free pigment dispersion may be mixed with water or other solvents and other additives in the desired amount to form the ink composition.

In the milling step the pigment is mixed with the dispersant and inert milling media. Mechanical energy is provided to the mixture and the milling media grinds and shears the pigment particles causing the pigment particles to break up into their primary particles. A hydroxyacid free dispersant composition prepared in accordance with the present invention is then added to the pigment particles to facilitate the fragmentation of the particles and maintain the dispersion.

Acceptable materials for use as milling media in the practice of this invention include, but are not limited to glasses, ceramics, metals, and plastics. Milling media should be inert and easily separable from the dispersion after the milling process is complete. Milling can take place in any suitable mill. Suitable mills include, but are no limited to an airjet mill, a roller mill, a ball mill, an attritor mill and a bead mill. A high speed mill is particularly useful. The duration of the milling step can vary widely and depends upon the pigment, mechanical means and initial and final particle size requirements. Upon completion of the milling process the pigment dispersion is preferably separated from the milling media by filtration.

### EXAMPLES

The present invention is now illustrated in greater detail with reference to the following Examples, but it should be understood that the present invention is not constructed as being limited thereto. The following Examples illustrate some embodiments of the present invention and experimental data pertaining to the problem solved by the present invention. They do not cover all embodiments of the present invention and should not be construed as doting so.

Filter clogging within the print head affects the print head performance. The specific mechanism is referred to as print head-ink starvation. As the filter becomes clogged, ink is no longer supplied to the firing chambers with the frequency required. Thus, as clogging of the print head filter increases, more missing nozzles appear during printing.

Print head performance in this example is graded in terms of the relative amount of nozzles missing during printing. Table 1 shows a scale for print performance.

TABLE 1
Grading Scale for Print Head Performance

| Print Performance | Description |
|---|---|
| Excellent | Printed through life with less that 0.5% of the nozzles |
| | out. |
| Good | Printed through life with 0.5 to 1% of the nozzles out. |
| Mediocre | Printed through life with 1 to 2.5% of the nozzles out. |
| Fail | Printed through life with >2.5% of the nozzles out. |

200 grams of an ink were filtered and the filtrate mass was recorded as a function of time. This yields a Filtration Curve. Furthermore, the amount of filtrate accumulated over the first 15 minutes is a parametric indication of filterability. This is referred to as the filterability value or filterability (grams of filtrate at 15 minutes).

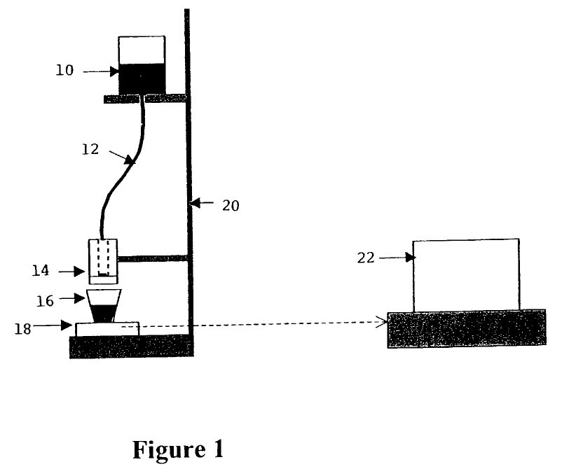

FIG. 1 illustrates the experimental setup. An ink reservoir 10 is suspended on a stand 20. The ink reservoir 10 is connected to a filter apparatus 14 suspended above a collection vessel 16. The collection vessel 16 is placed upon a scale 18 which measures the amount of ink which passes through the filter apparatus 14. The balance 18 is connected to a computer 22 which is used to record and analyze the data. The filters employed were from the same material and mesh size as those employed in the print head but of smaller surface area in order to accelerate the test. The hydrostatic pressure was kept constant at 25 cm of ink.

Inks Tested

Ink A comprises a pigment, acrylic polymer dispersant, co-solvents, penetrant, binder and DI water. The acrylic polymer dispersant may contain 5 to 100 ppm of the hydroxyacids. Ink A was made fresh for this test purpose.

Ink B comprises a different pigment, higher amount of acrylic polymer dispersant, different co-solvents and higher amount of binder. The higher amount of acrylic polymer dispersant in Ink B results in Ink B containing more hydroxyacids than Ink A.

Ink C has the exact formulation as Ink A except it was aged in 40° C. oven for 2 weeks in a sealed container.

Ink D has the exact formulation as Ink A except 10 ppm of a hydroxyacid was added to the ink.

Ink E has the exact formulation as Ink A except the acrylic polymer dispersant was purified by the ultrafiltration method of the present invention. Analysis showed that the ultrafiltration process removed all of the hydroxyacids in the dispersant.

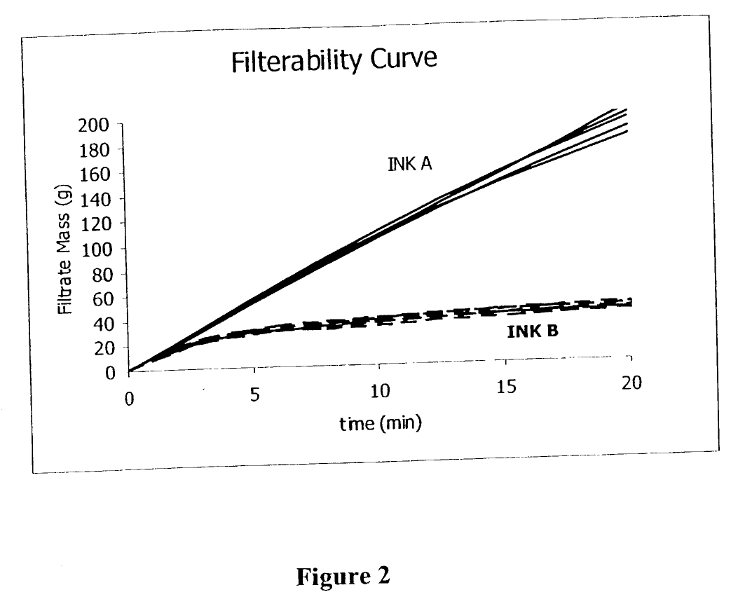

Table 2 shows the filterability of two of the baseline inks, Inks A and B. Ink A showed excellent print head performance throughout the test. Ink B failed print head reliability performance with multiple nozzles out. When analyzed, Ink B had completely clogged the print head filter. FIG. 2 shows the filterability curve of several replicates of Ink A and Ink B.

TABLE 2
Filtration Test Correlation to Print Head Performance

| | Print head Performance | Filterabilty (g) |
|---|---|---|
| Ink A | Excellent | 158 |
| Ink B | Fail | 40 |

Aging time and temperature had an effect on the filterability of the test inks. Table 3 illustrates the time-temperature dependence observed and its correlation to print performance. The data shows that an ink which performs well fresh (Ink A), does not necessarily do after aging (Ink C). Analytical work on the filter clog material of the failing inks showed concentrated amounts of hydroxyacids. Thus, as inks age, they cause more filter clogs and reduce print head reliability.

TABLE 3
Aging Correlation to Print Head Performance

| | Print head Performance | Filterabilty (g) |
|---|---|---|
| Ink A | Excellent | 158 |
| Ink B | Fail | 40 |
| Ink C | Mediocre | 110 |

To assess the effect of hydroxyacids on filterability, inks were spiked with additional hydroxyacids. Ink A was compared to Ink D, which has the same formulation as Ink A with the addition of 10 ppm hydroxyacids. This essentially accelerates the aging effects.

Table 4 shows that even trace amounts of hydroxyacids when added directly to an ink, will cause filter clogging behavior and poor performance. Ink D, with additional hydroxyacids showed greatly reduced filterability as compared to Ink A.

TABLE 4
Comparative Example 1

| | Aging Temp. | Aging Time | Filterability (g) |
|---|---|---|---|
| Ink A | amb | fresh | 158 |
| Ink D | amb | fresh | 110 |

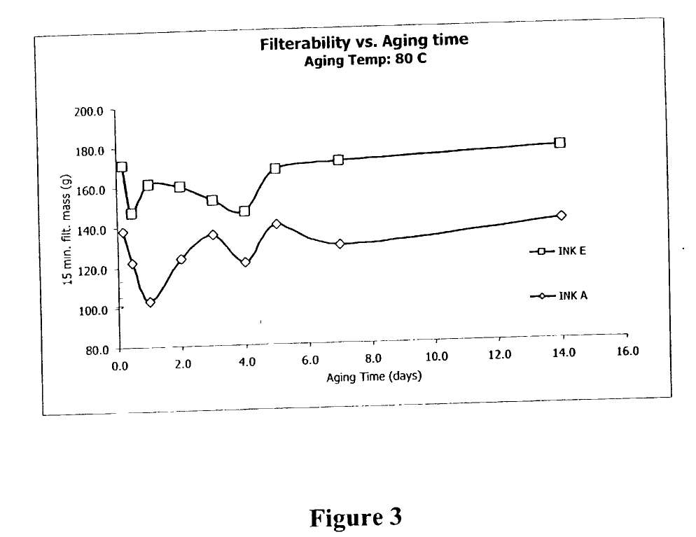

FIG. 3 shows the effect of cleaning the dispersant by ultrafiltration. Analytical work performed on the cleaned dispersant, Ink E, showed non-detectable amounts of hydroxyacids. Ink E, the cleaned dispersant, showed better filterability than uncleaned Ink A, indicating the absence of filter clogs.

FIG. 3 shows that after the removal of hydroxyacids, the aging or time-temperature behavior observed before with Ink A has greatly improved due to the reduction of clogging of the filter and less starvation on the print head. Thus, the removal of hydroxyacids results in the elimination of filter clogs in the print head and better print head performance.

Ultrafiltration

The following is a description of one embodiment of the ultrafiltration process of the present invention. This example is provided for illustrative purposes only and is not meant to be limiting in any way.

For the following example the ultrafiltration cartridge is a 1” HF1.0-43-PM1 Ultrafiltration Cartidge Part#720032 from Koch Membranes, and the pump is a 3.5 gallon per minute diaphragm pump (Jabsco model 30801-011).

One liter of dispersant solution containing hydroxyacids is charged into a 4 liter feed tank 30. The remainder of the feed tank is filled with DI water through the feed line 32. The pump 34 is started with the ball valve 36 open and the pressure gauge 38 reading 0.0 pounds per square inch (psi). Once the pump 34 is stable, the ball valve 36 is closed until the pressure gauge 38 reads 20 psi. Filtrate, consisting of DI water and small impurities such as hydroxyacids, will then start to flow out of the ultrafiltration cartridge 40 through the filtrate waste line 42. When the liquid level in the tank 30 reaches approximately 2 liters, more DI water is added to fill the tank 30. This process is repeated until analysis of the dispersant finds no impurity remaining. The liquid level in the tank 30 is then allowed to concentrate to the original level of approximately 1 liter. The purified dispersant solution is then removed from the tank and analyzed. The ultrafiltration system is then cleaned and a new batch of dispersant maybe cleaned.

The foregoing is considered as illustrative only of the principles of the present invention. Since numerous modifications and changes will readily occur to those skilled in the art, the foregoing is not intended to limit the invention to the exact construction and operation shown and described, and all suitable modifications and equivalents falling within the scope of the appended claims are deemed within the present inventive concept.

The features of the present invention, together with the other objectives of the invention, and along with the various features of novelty which characterize the invention, are pointed out with particularity in the claims annexed to and forming a part of this disclosure.

We claim:

1. A dispersant composition comprising a dispersant wherein hydroxyacids present in said dispersant have been removed.

2. The dispersant composition of claim 1, wherein said hydroxyacids were removed by a process comprising ultrafiltration.

3. The dispersant composition of claim 1, further comprising a pigment.

4. A pigment dispersion comprising; a dispersant wherein hydroxyacids present in said dispersant have been removed, and a pigment.

5. An ink composition comprising the dispersant composition of claim 1.

6. An ink composition comprising the pigment dispersion of claim 4.

7. An ink composition comprising the dispersant composition of claim 2.

8. A dispersant composition comprising a dispersant, wherein said dispersant was formed from materials comprising methacrylic acid, wherein hydroxyacids present in said dispersant have been removed.

9. A method of preparing a dispersant composition comprising the step of: removing hydroxyacids present in a dispersant from said dispersant.

10. A method of preparing an ink composition, comprising the steps of: removing hydroxyacids present in a dispersant from said dispersant to form a hydroxyacid free dispersant, combining said hydroxyacid free dispersant with a colorant to form a dispersion and adding a vehicle to said dispersion.

11. A method of preparing a dispersant composition, wherein an ultrafiltration process is applied to a dispersant comprising one or more hydroxyacids thereby separating the dispersant into a first stream comprising a hydroxyacid free dispersant composition and a second stream comprising said one or more hydroxyacids.

12. The product of the method of claim 11.
